(19) United States
(12) Patent Application Publication
(10) Pub. No.: US 2019/0054636 A1
(43) Pub. Date: Feb. 21, 2019

(54) ROBOT

(71) Applicant: Seiko Epson Corporation, Tokyo (JP)

(72) Inventors: Hajime KOBAYASHI, Chino (JP); Toshiyuki KAMIYA, Fujimi (JP)

(21) Appl. No.: 16/104,185

(22) Filed: Aug. 17, 2018

(30) Foreign Application Priority Data
Aug. 17, 2017 (JP) 2017-157435

(51) Int. Cl. B25J 17/02

(52) U.S. Cl. CPC B25J 17/02; B25J 13/085

(57) ABSTRACT

A robot includes a robot arm, a relay member fixed to a distal end part of the robot arm using a screw in a direction along a center axis of the robot arm and having an outer circumferential surface about the center axis, and a structure having an end effector and fixed in contact with the outer circumferential surface to the robot arm via the relay member.

### BACKGROUND

### 1. Technical Field

The present invention relates to a robot.

### 2. Related Art

Robots such as vertical articulated robots and horizontal articulated robots have robot arms, and generally, structures having end effectors such as hands are attached to distal ends of the robot arms.

For example, in a robot disclosed in Patent Document 1 (JP-A-2003-117868), a tool is detachably coupled to a robot arm via a coupling device. The coupling device includes a master plate attached to the robot arm, a tool plate to which the tool is attached, an attachment and detachment mechanism that attaches and detaches the tool plate to and from the master plate, and a positioning mechanism that positions the tool plate with respect to the master plate when the plates are coupled by the attachment and detachment mechanism. Here, the attachment and detachment mechanism has a piston unit and is adapted to switch between lock and release of the unit by reciprocating the piston unit.

However, in the robot disclosed in Patent Document 1, the coupling device has movable components including the piston unit and the attachment structure of the robot arm and the tool becomes complex and large. As a result, there are problems that the movable range of the robot having the end effector is limited and weight capacity of the robot is reduced.

### SUMMARY

An advantage of some aspects of the invention is to provide a robot in which an attachment structure of a robot arm and a structure having an end effector may be simplified and downsized.

The invention can be implemented as the following application examples or embodiments.

A robot according to an application example includes a robot arm, a relay member fixed to a distal end part of the robot arm using a screw in a direction along a center axis of the robot arm and having an outer circumferential surface about the center axis, and a structure having an end effector and fixed in contact with the outer circumferential surface to the robot arm via the relay member.

According to the robot, the relay member is fixed to the distal end part of the robot arm using the screw, and thus, fixation of the distal end part of the robot arm and the relay member may be realized by the relatively simple configuration. Further, the length direction of the screw is the direction along the center axis of the distal end part of the robot arm, and thereby, fixation of the distal end part of the robot arm and the relay member may be realized without the width of the relay member being made larger than the width of the distal end part. Accordingly, the relay member may be downsized. Furthermore, the structure having the end effector is attached in contact with the outer circumferential surface (the surface along the center axis of the distal end part of the robot arm) of the relay member to the robot arm via the relay member, and thus, fixation of the relay member and the structure may be realized without the width of the relay member being made larger than the width of the distal end part of the robot arm by the relatively simple configuration. Accordingly, simplification and downsizing of the attachment structure of the robot arm and the structure may be realized together with the effect by the above described fixation of the distal end part of the robot arm and the relay member (simplification and downsizing of the configuration).

In the robot according to the application example, it is preferable that the structure has a force detection sensor provided between the distal end part and the end effector.

With this configuration, the force detection sensor may be downsized.

In the robot according to the application example, it is preferable that, as seen from the direction along the center axis, a width of the relay member is smaller than a width of the distal end part.

With this configuration, the width of the structure having the end effector (particularly, the width of the end part of the structure on the robot arm side) may be made equal to or smaller than the width of the distal end part of the robot arm.

In the robot according to the application example, it is preferable that the structure has a wall portion provided along the outer circumferential surface of the relay member.

With this configuration, fixation of the relay member and the structure having the end effector may be realized without the width of the relay member being made larger than the width of the distal end part of the robot arm by the relatively simple configuration.

In the robot according to the application example, it is preferable that, as seen from the direction along the center axis, a width of the wall portion is equal to or smaller than a width of the distal end part.

With this configuration, downsizing of the structure having the end effector may be easily realized.

In the robot according to the application example, it is preferable to provide a screw placed in the wall portion in contact with the outer circumferential surface of the relay member.

With this configuration, the positions of the structure in the center axis direction and about the center axis with respect to the relay member may be regulated (fixed) by the relatively simple configuration.

In the robot according to the application example, it is preferable that one of the relay member and the wall portion has a convex portion, and the other has a guide groove that guides the convex portion in the direction along the center axis.

With this configuration, the position of the structure about the center axis with respect to the relay member may be regulated (fixed) by the relatively simple configuration.

In the robot according to the application example, it is preferable that the other has a regulating groove connected to the guide groove and regulating movement of the convex portion in the direction along the center axis.

With this configuration, the position of the structure in the center axis direction with respect to the relay member may be regulated (fixed) by the relatively simple configuration.

In the robot according to the application example, it is preferable that a male screw is provided in the outer circumferential surface of the relay member, and a female screw screwed with the male screw is provided in an inner circumferential surface of the wall portion.

With this configuration, the positions of the structure in the center axis direction and about the center axis with respect to the relay member may be regulated (fixed) by the relatively simple configuration.

### BRIEF DESCRIPTION OF THE DRAWINGS

The invention will be described with reference to the accompanying drawings, wherein like numbers reference like elements.

FIG. 1 is a perspective view showing a robot according to a first embodiment of the invention.

FIG. 2 is an exploded perspective view showing an attachment structure of a structure to a robot arm in the robot shown in FIG. 1.

FIG. 3 is a partially sectional side view of the attachment structure shown in FIG. 2.

FIG. 4 is a partially sectional side view showing an attachment structure of a structure to a robot arm according to a second embodiment of the invention.

FIG. 5 is a partially sectional side view showing an attachment structure of a structure to a robot arm according to a third embodiment of the invention.

FIG. 6 is a partially sectional side view showing a fitting part in the attachment structure shown in FIG. 5.

FIG. 7 is a partially sectional side view showing an attachment structure of a structure to a robot arm according to a fourth embodiment of the invention.

### DESCRIPTION OF EXEMPLARY EMBODIMENTS

As below, a robot according to the invention will be explained in detail based on embodiments shown in the accompanying drawings.

### First Embodiment

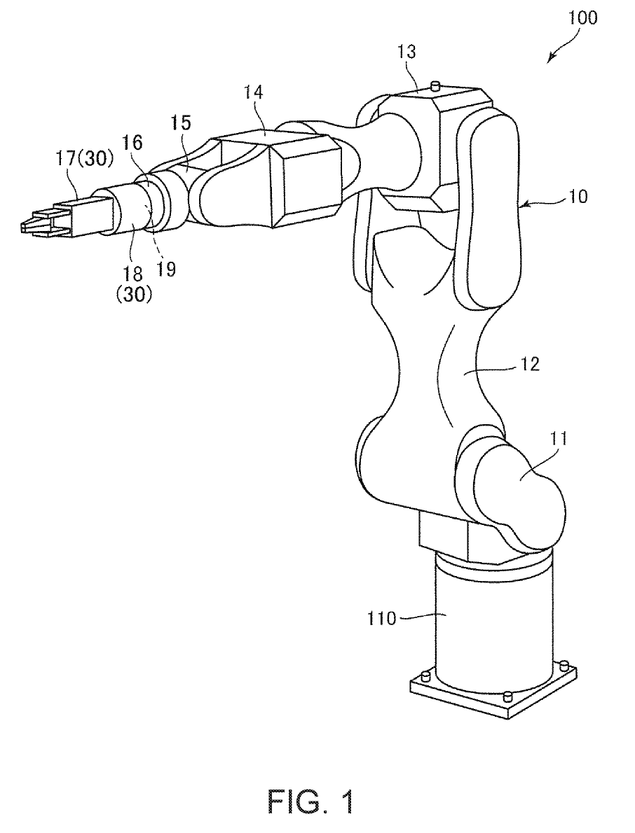

First, an outline of the robot will be explained with reference to FIG. 1.

FIG. 1 is a perspective view showing a robot according to the first embodiment of the invention.

A robot 100 shown in FIG. 1 is the so-called single-arm six-axis vertical articulated robot and used for work of feeding, removing, carrying, assembly, etc. of objects including precision apparatuses and components forming the apparatuses. The robot 100 has a base 110 and a robot arm 10 rotatably coupled to the base 110. Further, an end effector 17 is attached to the robot arm 10 via a relay member 19 and a force detection sensor 18.

The base 110 is fixed to e.g. a floor, wall, ceiling, movable platform, or the like. The robot arm 10 has an arm 11 (first arm) rotatably coupled to the base 110, an arm 12 (second arm) rotatably coupled to the arm 11, an arm 13 (third arm) rotatably coupled to the arm 12, an arm 14 (fourth arm) rotatably coupled to the arm 13, an arm 15 (fifth arm) rotatably coupled to the arm 14, and an arm 16 (sixth arm) rotatably coupled to the arm 15. In the respective joint parts of these arms 11 to 16, drive units having motors and reducers (not shown) are provided and the respective arms 11 to 16 rotate by driving of the respective drive units. Further, the driving of the respective drive units is controlled by a control unit (not shown).

A structure 30 is attached to the arm 16 located in the distal end part of the robot arm 10 via the relay member 19. The structure 30 has the force detection sensor 18 (force detection sensor) fixed to the relay member 19 and the end effector 17 attached to the force detection sensor 18.

The force detection sensor 18 detects forces (including moment) applied to the end effector 17.

The end effector 17 is a tool for performing work on an object as a work object of the robot 100 and includes a hand having a function of grasping the object. Note that a tool for details of work or the like of the robot 100 may be used as the end effector 17 and is not limited to the hand, but may be e.g. a screw tightening tool for tightening screws or the like.

The relay member 19 is a member used for attaching the force detection sensor 18 to the robot arm 10.

### Attachment Structure of Structure to Robot Arm

As below, an attachment structure of the structure 30 (force detection sensor 18) to the robot arm 10 will be explained.

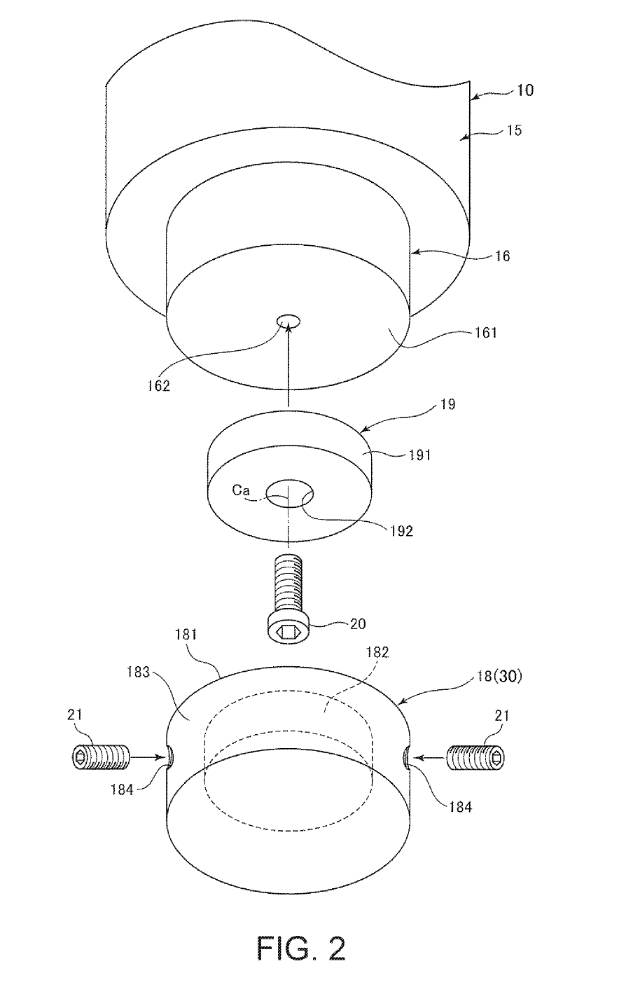

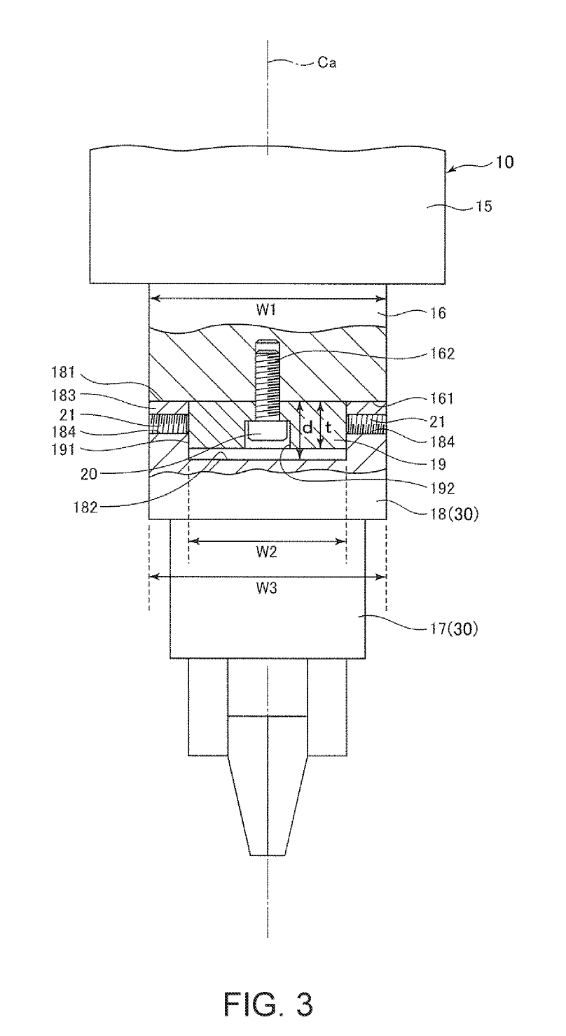

FIG. 2 is an exploded perspective view showing the attachment structure of the structure to the robot arm in the robot shown in FIG. 1. FIG. 3 is a partially sectional side view of the attachment structure shown in FIG. 2.

As shown in FIGS. 2 and 3, a screw hole 162 is provided in a distal end surface 161 of the arm 16. Here, the distal end surface 161 is a flat surface perpendicular to a center axis Ca of the arm 16. Further, the screw hole 162 extends in a direction along the center axis Ca. In the embodiment, the axis line of the screw hole 162 coincides with the center axis Ca.

The relay member 19 has a plate shape. Here, the relay member 19 has a circular shape as seen from the direction along the center axis Ca of the arm 16 (hereinafter, also referred to as “plan view”). Thereby, before fixation by screws 21, which will be described later, the posture of the force detection sensor 18 around the center axis Ca may be adjusted with the relay member 19 inserted into a concave portion 182, which will be described later. Further, in the relay member 19, a hole 192 penetrating the member in the thickness direction is provided in the center part. As shown in FIG. 3, the hole 192 includes a smaller diameter portion having a width slightly larger than the shaft portion of a screw 20, which will be described later, and a larger diameter portion slightly larger than the head portion of the screw 20 so that the width on the robot arm 10 side may be smaller, and a step is provided between the portions.

Note that the outer shape of the relay member 19 in the plan view is not limited to the above described circular shape, but may be e.g. a polygonal shape such as a rectangular shape or pentagonal shape. In this case, an appropriate change such as conformation of the plan view shape of the concave portion 182 of the force detection sensor 18, which will be described later, to the plan view shape of the relay member 19 is made, and thereby, the positions of the relay member 19 and the force detection sensor 18 about the center axis Ca may be regulated.

The screw 20 is inserted from the distal end surface 161 into the hole 192 of the relay member 19 and screwed with the above described screw hole 162. Thereby, the relay member 19 is fixed to the robot arm 10 by the screw 20. Here, the screw 20 is a bolt having the shaft portion and the head portion and engages (in contact) with the step of the hole 192 with the head portion of the screw 20 held within the larger diameter portion of the above described hole 192. Note that, in the drawing, a hexagon socket is provided in the head portion of the screw 20, however, screws with various head portions of pan head, round head, hexagon head, countersunk head, oval countersunk head, etc. may be used.

As described above, the relay member 19 is fixed to the robot arm 10 using the screw 20. Here, though not shown, as appropriate, a concave portion may be provided in a position off the center axis Ca in one of the distal end surface 161 of the robot arm 10 and a surface of the relay member 19 on the distal end surface 161 side, and a convex portion to be inserted into the concave portion may be provided in the other. By the concave portion and the convex portion, rotation of the relay member 19 about the center axis Ca with respect to the robot arm 10 may be regulated.

Note that, in the drawings, the single screw 20 is provided, however, the relay member 19 maybe fixed to the robot arm 10 using a plurality of the screws 20. In this case, a plurality of screw holes may be provided in the distal end surface 161 of the robot arm, and a plurality of corresponding holes for insertion of the screws 20 may be provided in the relay member 19. The relay member 19 is fixed to the robot arm 10 using the plurality of the screws 20, and thereby, the fixation may be stronger and the rotation of the relay member 19 about the center axis Ca with respect to the robot arm 10 may be regulated.

The force detection sensor 18 is a six-axis force sensor that can detect six axis components of an external force applied to the force detection sensor 18. Here, the six axis components include translational force (shear force) components in the respective directions of three axes orthogonal to one another and rotational force (moment) components about the respective three axes.

The force detection sensor 18 has a case and a plurality of sensor devices housed within the case (not shown). Here, the case has a pair of plates and a cover that covers between the outer peripheral portions of the plates, and each sensor device includes a piezoelectric element or the like and outputs a signal according to a force applied between the pair of plates. Thereby, the six axis components of an external force applied to the force detection sensor 18 may be detected based on the signals of the plurality of sensor devices. Note that the number of detection axes of the force detection sensor 18 is not limited to six, but may be e.g. from one to five.

The force detection sensor 18 has a circular cylindrical outer shape and has two end surfaces (bottom surfaces). Further, an opening part of the concave portion 182 is provided in one end surface 181 of the two end surfaces (the plate surface of one plate of the above described pair of plates or a plate-like member attached to the plate). The concave portion 182 has a shape conforming to the outer shape of the relay member 19 (a circular shape in the embodiment) in the plan view. The above described relay member 19 is inserted into the concave portion 182.

Here, the width of the concave portion 182 is equal to or slightly larger than a width W2 of the relay member 19. A depth d of the concave portion 182 is larger than a thickness t of the relay member 19. Accordingly, when the relay member 19 is inserted into the concave portion 182, the end surface 181 of the force detection sensor 18 may be brought into contact with the distal end surface 161 of the robot arm 10 without contact of the end surface of the relay member 19 on the opposite side to the end surface 181 with the bottom surface of the concave portion 182. Thereby, positioning of the robot arm 10 and the force detection sensor 18 in the direction of the center axis Ca may be performed with higher accuracy.

Note that, even in the case where the depth d of the concave portion 182 is smaller than the thickness t of the relay member 19, when the relay member 19 is inserted into the concave portion 182, the end surface of the relay member 19 on the opposite side to the end surface 181 is brought into contact with the bottom surface of the concave portion 182 without contact of the end surface 181 of the force detection sensor 18 with the distal end surface 161 of the robot arm 10, and thereby, positioning of the robot arm 10 and the force detection sensor 18 in the center axis Ca direction may be performed. Note that, in the case where the depth d of the concave portion 182 is larger than the thickness t of the relay member 19, there is an advantage that mechanical strength of the connection structure between the robot arm 10 and the force detection sensor 18 (structure 30) is made higher more easily because positioning is performed in a position farther from the center axis Ca. Although the depth d of the concave portion 182 may be equal to the thickness t of the relay member 19, it is difficult to make the depth d of the concave portion 182 completely equal to the thickness t of the relay member 19 due to a machining error or the like. Accordingly, in view of improvement of productivity, it is preferable that the depth d of the concave portion 182 is different from the thickness t of the relay member 19 (a difference larger than the machining error, e.g. a difference equal to or larger than 1 mm is provided).

The concave portion 182 is provided on the end surface 181 side (the opening part of the concave portion 182 is provided in the end surface 181), and thereby, a wall portion 183 is provided in the force detection sensor 18. That is, the force detection sensor 18 includes the wall portion 183 forming the side wall of the concave portion 182. In the wall portion 183, a plurality of (two in the drawing) screw holes 184 penetrating in the thickness direction are provided. The screws 21 are screwed into the respective screw holes 184. The screws 21 are tightened, and thereby, the screws 21 are brought into contact with an outer circumferential surface 191 of the relay member 19 and the positions of the wall portion 183 in the center axis Ca direction and about the center axis Ca with respect to the relay member 19 may be fixed. Here, the screws 21 are hexagon socket set screws (set screws).

Note that the screws 21 are not limited to the hexagon socket set screws, but various screws such as slotted set screws or cross-recessed set screws may be used. Further, the number of screws 21 is two in the drawing, but one, three, or more screws 21 maybe used. In this case, a plurality of screw holes may be provided in the wall portion 183. If the number of screws 21 is three, the respective center axes of the concave portion 182 of the force detection sensor 18 and the relay member 19 may be easily aligned.

The end effector 17 is attached to the end surface of the force detection sensor 18 on the opposite side to the end surface 181 (the plate surface of the other plate of the above described pair of plates or the plate-like member attached to the plate) by a known method. Note that the attachment structure of the force detection sensor 18 and the end effector 17 may be the same as the attachment structure of the force detection sensor 18 and the robot arm 10 using the above described relay member 19.

As described above, the robot 100 includes the robot arm 10, the relay member 19 fixed to the distal end part of the robot arm 10 (more specifically, the distal end surface 161 of the arm 16) using the screw 20 in the direction along the center axis Ca of the arm 16 and having the outer circumferential surface about the center axis of the arm 16, and the structure 30 having the end effector 17 and fixed in contact with the outer circumferential surface 191 of the relay member 19 to the robot arm 10 via the relay member 19.

According to the robot 100, the relay member 19 is fixed to the distal end part of the robot arm 10 using the screw 20, and thus, fixation of the distal end part of the robot arm 10 and the relay member 19 may be realized by the relatively simple configuration. Further, the length direction of the screw 20 is the direction along the center axis Ca of the arm 16, and thereby, fixation of the distal end part of the robot arm 10 and the relay member 19 may be realized without the width W2 of the relay member 19 being made larger than the width W1 of the distal end part. Accordingly, the relay member 19 may be downsized. Furthermore, the structure 30 having the end effector 17 is attached in contact with the outer circumferential surface 191 of the relay member 19 (the surface along about the center axis Ca of the arm 16) to the robot arm 10 via the relay member 19, and thus, fixation of the relay member 19 and the structure 30 maybe realized without the width W2 of the relay member 19 being made larger than the width W1 of the distal end part of the robot arm 10 by the relatively simple configuration. Accordingly, simplification and downsizing of the attachment structure of the robot arm 10 and the structure 30 may be realized together with the effect by the above described fixation of the robot arm 10 and the relay member 19 (simplification and downsizing of the configuration).

In the embodiment, as seen from the direction along the center axis Ca, the width W2 of the relay member 19 is smaller than the width W1 of the distal end part of the robot arm 10. Preferably, W2/W1 is from 0.2 to 0.95. Thereby, a width W3 of the structure 30 having the end effector 17 (particularly, the width of the end part of the structure 30 on the robot arm 10 side) may be made equal to or smaller than the width W1 of the distal end part (arm 16) of the robot arm 10.

Here, as described above, the concave portion 182 into which the relay member 19 is inserted is provided in the structure 30. Therefore, the structure 30 has the wall portion 183 provided along the outer circumferential surface 191 of the relay member 19. Thereby, fixation of the relay member 19 and the structure 30 having the end effector 17 may be realized without the width W2 of the relay member 19 being made larger than the width W1 of the distal end part of the robot arm 10 by the relatively simple configuration of inserting the relay member 19 into the concave portion 182.

Further, as seen from the direction along the center axis Ca, the width of the wall portion 183 (the width W3 of the structure 30) is equal to or smaller than the width W1 of the distal end part (arm 16) of the robot arm 10. Thereby, downsizing of the structure 30 having the end effector 17 may be easily realized. In the point of view, it is preferable that the structure 30 satisfies W1≥W3>W2.

In the wall portion 183, the plurality of (two in the embodiment) screws 21 are embedded and the length directions thereof are along the thickness direction of the wall portion 183. By these screws 21, the relay member 19 is fixed not to slip out from the concave portion 182. As described above, the robot 100 includes the plurality of screws 21 embedded in the wall portion 183 in contact with the outer circumferential surface 191 of the relay member 19. Thereby, the positions of the structure 30 in the center axis Ca direction and about the center axis Ca with respect to the relay member 19 may be regulated (fixed) by the relatively simple configuration. Note that the number of screws 21 is not limited to two, but may be one, three, or more.

In the embodiment, the end effector 17 is attached to the robot arm 10 via the force detection sensor 18. That is, the structure 30 has the force detection sensor 18 provided between the distal end part of the robot arm 10 (more specifically, the distal end surface 161) and the end effector 17. Thereby, downsizing of the force detection sensor 18 may be realized.

### Second Embodiment

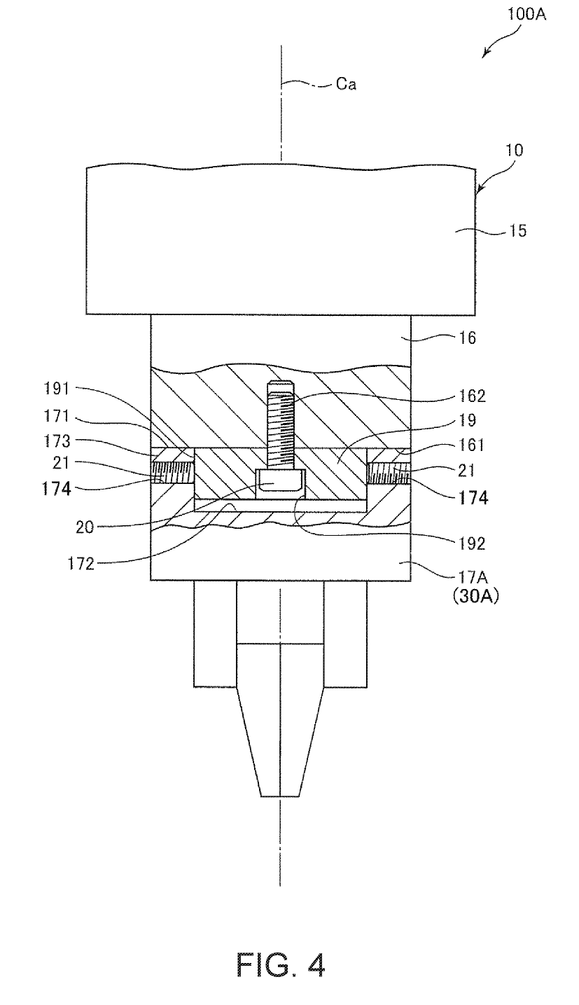

FIG. 4 is a partially sectional side view showing an attachment structure of a structure to a robot arm according to the second embodiment of the invention.

As below, the second embodiment will be explained with a focus on the differences from the above described embodiment and the explanation of the same items will be omitted. In FIG. 4, the same configurations as those of the above described embodiment have the same signs.

In a robot 100A shown in FIG. 4, an end effector 17A (structure 30A) is directly attached to the robot arm 10 via the relay member 19.

Here, in an end surface 171 of the end effector 17A on the robot arm 10 side, a concave portion 172 similar to the concave portion 182 of the above described first embodiment is provided. The relay member 19 is inserted into the concave portion 172.

With the concave portion 172 provided in the end surface 171, a wall portion 173 is provided in the end effector 17A. That is, the end effector 17A includes a wall portion 173 forming the side wall of the concave portion 172. In the wall portion 173, a plurality of (two in the drawing) screw holes 174 penetrating in the thickness direction are provided. The respective screw holes 174 have the same configurations as those of the screw holes 184 of the above described first embodiment, and the screws 21 are screwed into the respective screw holes 174. The screws 21 are tightened, and thereby, the screws 21 are brought into contact with the outer circumferential surface 191 of the relay member 19 and the positions of the wall portion 173 in the center axis Ca direction and about the center axis Ca with respect to the relay member 19 may be fixed.

As described above, the robot 100A includes the robot arm 10, the relay member 19 fixed to the distal end part of the robot arm 10 (more specifically, the distal end surface 161 of the arm 16) using the screw 20 in the direction along the center axis Ca of the arm 16, and the structure 30A having the end effector 17 and fixed in contact with the outer circumferential surface 191 of the relay member 19 to the robot arm 10 via the relay member 19.

In the embodiment, the end effector 17A is directly attached to the robot arm 10. That is, the end effector 17A forms the structure 30A. Thereby, downsizing of the end effector 17A (structure 30A) may be realized.

Here, as described above, the concave portion 172 into which the relay member 19 is inserted is provided in the structure 30A. Therefore, the structure 30A has the wall portion 173 provided along the outer circumferential surface 191 of the relay member 19. Thereby, fixation of the relay member 19 and the structure 30A having the end effector 17A may be realized without the width W2 of the relay member 19 being made larger than the width W1 of the distal end part of the robot arm 10 by the relatively simple configuration of inserting the relay member 19 into the concave portion 172.

Further, as seen from the direction along the center axis Ca, the width of the wall portion 173 (the width W3 of the structure 30A) is equal to or smaller than the width W1 of the distal end part of the robot arm 10. Thereby, downsizing of the structure 30A having the end effector 17A may be easily realized.

In the wall portion 173, the plurality of (two in the embodiment) screws 21 are embedded and the length directions thereof are along the thickness direction of the wall portion 173. By these screws 21, the relay member 19 is fixed not to slip out from the concave portion 172. As described above, the robot 100A includes the plurality of screws 21 embedded in the wall portion 173 in contact with the outer circumferential surface 191 of the relay member 19. Thereby, the positions of the structure 30A in the center axis Ca direction and about the center axis Ca with respect to the relay member 19 may be regulated (fixed) by the relatively simple configuration. Note that the number of screws 21 is not limited to two, but may be one, three, or more. The type, form, etc. of the screws 21 are not particularly limited, but it is preferable for downsizing that set screws without head portions are used and the base end portions thereof do not project outward from the outer circumferential surface of the wall portion 173.

According to the above described second embodiment, the attachment structure of the robot arm 10 and the structure 30A having the end effector 17A may be simplified and downsized.

### Third Embodiment

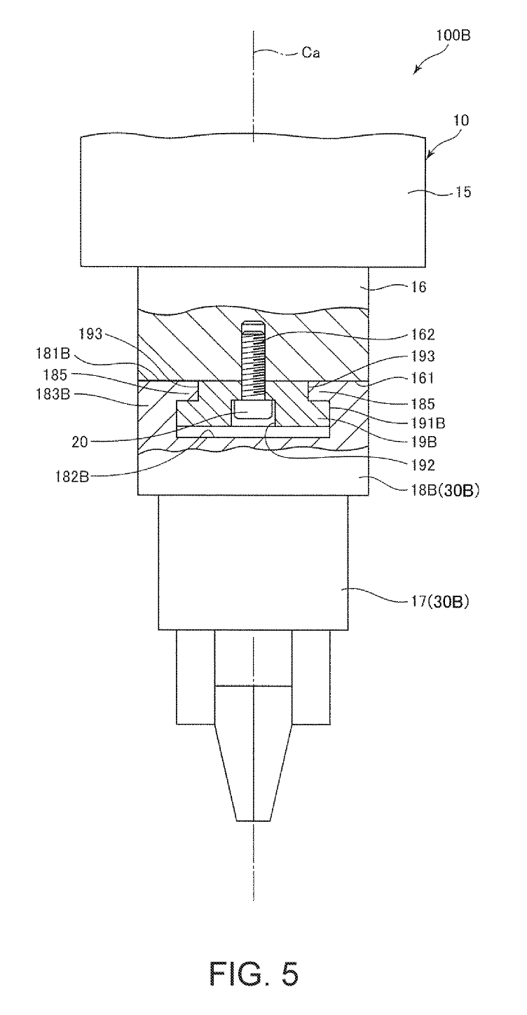

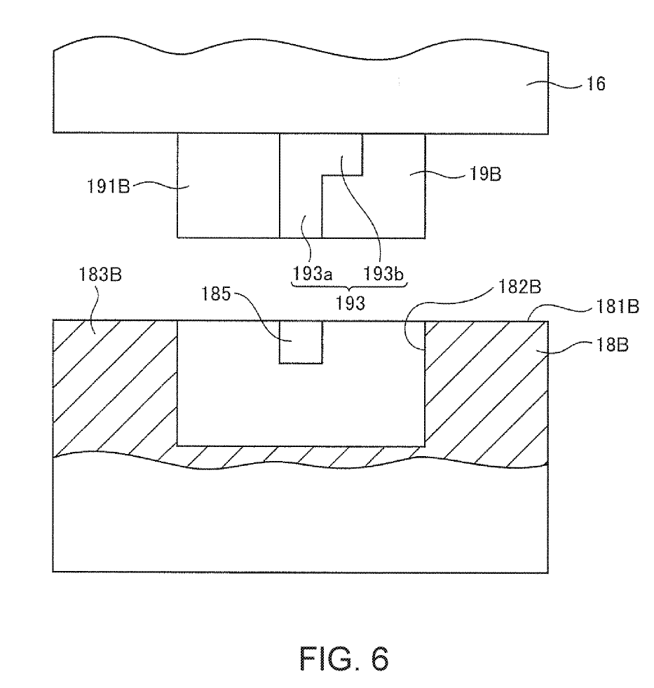

FIG. 5 is a partially sectional side view showing an attachment structure of a structure to a robot arm according to the third embodiment of the invention. FIG. 6 is a partially sectional side view showing a fitting part in the attachment structure shown in FIG. 5.

As below, the third embodiment will be explained with a focus on the differences from the above described embodiments and the explanation of the same items will be omitted. In FIGS. 5 and 6, the same configurations as those of the above described embodiments have the same signs.

In a robot 100B shown in FIG. 5, a structure 30B is attached to the robot arm 10 via a relay member 19B. The structure 30B has a force detection sensor 18B (force detection sensor) fixed to the relay member 19B and the end effector 17 attached to the force detection sensor 18B.

Here, the force detection sensor 18B has a circular cylindrical outer shape and has two end surfaces (bottom surfaces). Further, a concave portion 182B into which the relay member 19B is inserted is provided in one end surface 181B of the two end surfaces. With the concave portion 182B provided in the end surface 181B, a wall portion 183B is provided in the force detection sensor 18B. That is, the force detection sensor 18B includes the wall portion 183B forming the side wall of the concave portion 182B.

As shown in FIG. 6, grooves 193 are provided in an outer circumferential surface 191B of the relay member 19B. The groove 193 has a guide groove 193a extending in the direction along (parallel to) the center axis Ca, and a regulating groove 193b extending from the guide groove 193a in the circumferential direction about the center axis Ca. In this regard, convex portions 185 that engage with the grooves 193 are provided in the inner circumferential surface of the concave portion 182B.

In the robot 100B, for insertion of the relay member 19B into the concave portion 182B, the relay member 19B and the concave portion 182B are relatively rotationally operated about the center axis Ca after the convex portion 185 is moved along the guide groove 193a, and thereby, the convex portion 185 is engaged with the regulating groove 193b. Thereby, with the relay member 19B inserted into the concave portion 182B at a desired depth, the relay member 19B may be prevented from slipping out from the concave portion 182B.

Note that, in the drawing, the numbers of grooves 193 and convex portions 185 are respectively two, but may be respectively one, three, or more. In this case, the grooves 193 corresponding to the respective convex portions 185 may be provided in the relay member 19B, and the number of grooves 193 may be the same or larger than the number of convex portions 185. Further, the shapes of the convex portions 185 and the grooves 193 are not limited to the shapes in the drawings.

As described above, the robot 100B includes the robot arm 10, the relay member 19B fixed to the distal end part of the robot arm 10 (more specifically, the distal end surface 161) using the screw 20 in the direction along the center axis Ca of the arm 16, and the structure 30B having the end effector 17 and attached in contact with the outer circumferential surface 191B of the relay member 19B to the robot arm 10 via the relay member 19B.

Here, as described above, the concave portion 182B into which the relay member 19B is inserted is provided in the structure 30B. Therefore, the structure 30B has the wall portion 183B provided along the outer circumferential surface 191B of the relay member 19B. Thereby, fixation of the relay member 19B and the structure 30B having the end effector 17 maybe realized without a width W2 of the relay member 19B being made larger than the width W1 of the distal end part of the robot arm 10 by the relatively simple configuration of inserting the relay member 19B into the concave portion 182B.

In the embodiment, one of the relay member 19B and the wall portion 183B (the wall portion 183B in the embodiment) has the convex portions 185. On the other hand, the other of the relay member 19B and the wall portion 183B (the relay member 19B in the embodiment) has the guide grooves 193a that guide the convex portions 185 along the center axis Ca. Thereby, the position of the structure 30B about the center axis Ca with respect to the relay member 19B may be regulated (fixed) by the relatively simple configuration.

Further, the other of the relay member 19B and the wall portion 183B (the relay member 19B in the embodiment) has the regulating grooves 193b connected to the guide grooves 193a and regulating the movement of the convex portions 185 along the center axis Ca. Thereby, the position of the structure 30B in the center axis Ca direction with respect to the relay member 19B may be regulated (fixed) by the relatively simple configuration.

Note that, like the screws 21 of the above described first, second embodiments, the wall portion 183B may be fixed to the relay member 19B by at least one screw embedded in the thickness direction of the wall portion 183B. In this case, the above described regulating grooves 193b may be omitted.

According to the above described third embodiment, the attachment structure of the robot arm 10 and the structure 30B having the end effector 17 may be simplified and downsized.

### Fourth Embodiment

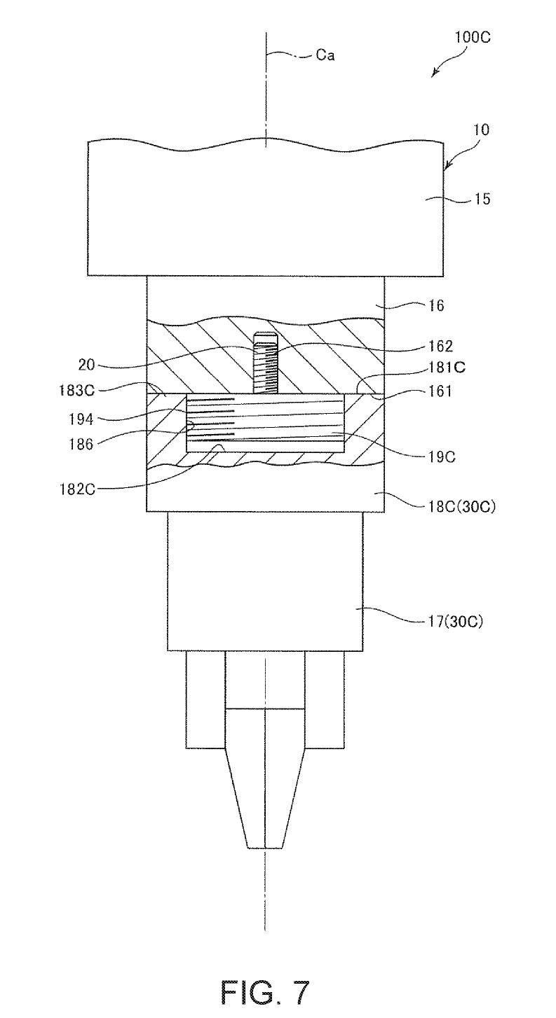

FIG. 7 is a partially sectional side view showing an attachment structure of a structure to a robot arm according to the fourth embodiment of the invention.

As below, the fourth embodiment will be explained with a focus on the differences from the above described embodiments and the explanation of the same items will be omitted. In FIG. 7, the same configurations as those of the above described embodiments have the same signs.

In a robot 100C shown in FIG. 7, a structure 30C is attached to the robot arm 10 via a relay member 19C. The structure 30C has a force detection sensor 18C (force detection sensor) fixed to the relay member 19C and the end effector 17 attached to the force detection sensor 18C.

Here, the force detection sensor 18C has a circular cylindrical outer shape and has two end surfaces (bottom surfaces). Further, a concave portion 182C into which the relay member 19C is inserted is provided in one end surface 181C of the two end surfaces. With the concave portion 182C provided in the end surface 181C, a wall portion 183C is provided in the force detection sensor 18C. That is, the force detection sensor 18C includes the wall portion 183C forming the side wall of the concave portion 182C.

A male screw is provided in an outer circumferential surface 194 of the relay member 19C. That is, the relay member 19C itself is the male screw. On the other hand, a female screw is provided in the inner circumferential surface of the concave portion 182C. That is, the concave portion 182C itself is the female screw.

In the robot 100C, for insertion of the relay member 19C into the concave portion 182C, the relay member 19C and the concave portion 182C are relatively rotationally operated about the center axis Ca, and thereby, the outer circumferential surface 194 (male screw) of the relay member 19C and the concave portion 182C (female screw) are screwed together. Thereby, with the relay member 19C inserted into the concave portion 182C at a desired depth (with the end surface 181C in contact with the distal end surface 161), the robot arm 10 and the force detection sensor 18C may be fixed via the relay member 19C.

As described above, the robot 100C includes the robot arm 10, the relay member 19C fixed to the distal end part of the robot arm 10 (more specifically, the distal end surface 161) using the screw 20 in the direction along the center axis Ca of the distal end part, and the structure 30C having the end effector 17 and attached in contact with the outer circumferential surface 194 of the relay member 19C to the robot arm 10 via the relay member 19C.

Here, as described above, the concave portion 182C into which the relay member 19C is inserted is provided in the structure 30C. Therefore, the structure 30C has the wall portion 183C provided along the outer circumferential surface 194 of the relay member 19C. Thereby, fixation of the relay member 19C and the structure 30C having the end effector 17 maybe realized without a width W2 of the relay member 19C being made larger than the width W1 of the distal end part of the robot arm 10 by the relatively simple configuration of inserting the relay member 19C into the concave portion 182C.

In the embodiment, the male screw is provided in the outer circumferential surface 194 of the relay member 19C. On the other hand, the female screw screwed with the male screw of the outer circumferential surface 194 is provided in the inner circumferential surface 186 of the wall portion 183C. By the male screw and the female screw, the positions of the structure 30C in the center axis Ca direction and about the center axis Ca with respect to the relay member 19C may be regulated (fixed) by the relatively simple configuration.

Note that, like the screws 21 of the above described first, second embodiments, the wall portion 183C may be fixed to the relay member 19C by at least one screw embedded in the thickness direction of the wall portion 183C.

According to the above described fourth embodiment, the attachment structure of the robot arm 10 and the structure 30C having the end effector 17 may be simplified and downsized.

As above, the robot according to the invention is explained based on the illustrated embodiments, however, the invention is not limited to those. The configurations of the respective parts may be replaced by arbitrary configurations having the same functions. Further, other arbitrary configurations may be added to the invention.

Alternatively, the invention may be a combination of any two or more configurations (features) of the above described embodiments.

The robot according to the invention is not limited to the single-arm robot, but may be another robot such as e.g. a dual-arm robot or scalar robot as long as the robot has a robot arm. Further, the number of arms (the number of joints) of the robot arm is not limited to the number in the above described embodiments (six), but may be one to five, seven, or more.

As long as the structure attached to the distal end part of the robot arm via the relay member has at least the end effector, an arbitrary structure, e.g. a camera, contact sensor, or the like may be provided in addition to the above described end effector and force detection sensor.

Further, in the above described embodiments, the case where the end effector is the hand is explained as an example, however, the end effector is not limited to the illustrated hand form or the hand, but may be other various types of end effectors than the hand.

The entire disclosure of Japanese Patent Application No. 2017-157435, filed Aug. 17, 2017 is expressly incorporated by reference herein.

What is claimed is:

1. A robot comprising:
a robot arm;
a relay member fixed to a distal end part of the robot arm using a screw in a direction along a center axis of the robot arm and having an outer circumferential surface about the center axis; and
a structure having an end effector and fixed in contact with the outer circumferential surface to the robot arm via the relay member.

2. The robot according to claim 1, wherein the structure has a force detection sensor provided between the distal end part and the end effector.

3. The robot according to claim 1, wherein, as seen from the direction along the center axis, a width of the relay member is smaller than a width of the distal end part.

4. The robot according to claim 1, wherein the structure has a wall portion provided along the outer circumferential surface of the relay member.

5. The robot according to claim 4, wherein, as seen from the direction along the center axis, a width of the wall portion is equal to or smaller than a width of the distal end part.

6. The robot according to claim 4, further comprising a screw placed in the wall portion in contact with the outer circumferential surface of the relay member.

7. The robot according to claim 4, wherein one of the relay member and the wall portion has a convex portion, and
the other has a guide groove that guides the convex portion in the direction along the center axis.

8. The robot according to claim 7, wherein the other has a regulating groove connected to the guide groove and regulating movement of the convex portion in the direction along the center axis.

9. The robot according to claim 4, wherein a male screw is provided in the outer circumferential surface of the relay member, and
a female screw screwed with the male screw is provided in an inner circumferential surface of the wall portion.
